(19) United States
(12) Patent Application Publication
(10) Pub. No.: US 2026/0205665 A1
(43) Pub. Date: Jul. 16, 2026

(54) AUTOMATED MEANS FOR OBTAINING AND PROCESSING INTERACTIVE CONTENT ASSOCIATED WITH VISUAL CONTENT

(71) Applicant: Macro Hardworks LLC, Cincinnati, OH (US)

(72) Inventors: Quang Son Pham, Oxford, OH (US); Kyle Bavis, Cincinnati, OH (US)

(21) Appl. No.: 18/440,538

(22) Filed: Feb. 13, 2024

(51) Int. Cl. H04N 21/4725; G06K 19/06; H04N 21/422; H04N 21/858

(52) U.S. Cl. CPC H04N 21/4725; H04N 21/42203; H04N 21/858; G06K 19/06037

(57) ABSTRACT

Systems, methods, and other embodiments associated with an automated means for providing an engaging user experience using interactive content are described. In one embodiment, a method includes displaying, on a graphical user interface (GUI), an embedded scannable content and a media content, the embedded scannable content being configured for visual display during playback of the media content, and the embedded scannable content being configured to include information for retrieving an interactive content having one or more data blocks. The example method may also include receiving and processing an interaction in response to the embedded scannable content being displayed, the interaction triggering retrieval and processing of the embedded scannable content that includes retrieving and processing one or more data blocks associated with the interactive content embedded within the embedded scannable content.

### TECHNICAL FIELD

The embodiments generally relate to visually encoded data, and more particularly, relates to methods, devices, and systems for creating, displaying, capturing, and processing visually encoded data to automate obtaining and processing interactive content associated with visual content.

### BACKGROUND

Social media and streaming services are prevalent in our lives allowing us to make connections with likeminded people, view and broadcast content that matters to us, and learn and experience something new. Generally, viewable content from social media and streaming services may be presented to users through a graphical user interface on a webpage, the viewable content can include a video, a slideshow presentation, images, and other visual media. Users engage with the content by viewing content within a social media site or a streaming service that presents visual information then navigating through various parts of a webpage, graphical user interface, or the content itself to obtain more information. The user experience of navigating through online content and visual media to obtain more information however often involves a lengthy or cumbersome process that can often hinder user experience and lower user engagement.

For example, content creators often direct viewers to a link in their profile, however this requires multiple steps from the viewer of: exiting the viewable content, navigating through the webpage to find the creator's profile link, and then opening the link to obtain more information. Moreover, on different computing devices the experience can be substantially different, for example, on a laptop computer the user display can be filled with advertising and marketing links and images, and the content creator's profile link can be at a distant corner and difficult find and access. Similarly, on mobile devices content creator profiles can vary from site to site, some sites require accessing the profile by searching the graphical user interface of the viewable content, and other sites require exiting the viewable content then navigating a webpage to find the content creator's profile link. Further, websites and graphical user interfaces often restrict access to, or nest, links and information which requires viewers to expand multiple layers or visual overlays to find the content creator's profile.

As another example, content creators may verbally mention or display a uniform resource locator (URL) in their videos for viewers to obtain more information and engage with the content. However, this requires the viewer's effort to remember or manually type the URL which can be error-prone and inconvenient that can reduce user engagement. Moreover, content creators may overlay their videos with a watermarked URL however this also requires the viewer's effort to remember or manually type the URL which can be error-prone and inconvenient and can detract from the visual appeal of the video.

Another example involves content creators may use visual cues or call-to-action buttons within the video, however these cues and buttons are often not clickable and serve only as a reminder or visual prompt for viewers to navigate the webpage for more information. This can lower user engagement as it requires effort from viewers to navigate through a graphical user interface or webpage to obtain more information to maintain user engagement. Similarly, content creators may verbally or visually encourage viewers to send a direct message to the content creator to receive a link or more information, however this process is time-consuming and inefficient both for the viewer and the creator. This can often hinder user experience and lower user engagement as it requires prompt response and effort on both viewers and content creators to maintain user engagement.

Still another example involves third-party link services used to consolidate multiple links into one. While this simplifies the process of navigating through the viewable content and webpage, it still requires viewers to navigate away from the video to the content creator's profile. Moreover, the viewer may still be required to navigate through a content creator's profile to find relevant information pertaining to the viewed content. This can often hinder user experience and lower user engagement as it requires prompt effort from viewers to maintain user engagement.

As described above, user experience of navigating through online content and visual media to obtain more information however often involves a lengthy or cumbersome process that can often hinder user experience and lower user engagement. Viewers are often required to make significant effort such as remembering and typing out URLs or navigating away from the viewable content to access links. Further, graphical user interfaces and social media and streaming services platforms often restrict linking in video descriptions to prevent spam and keep users on their platform thereby limiting direct redirection capabilities and making user navigation away from the content cumbersome.

The above examples illustrate multi-step process and inconvenience experienced by viewers that can lead to a lower conversion rate and reduced user engagement as potential visitors may lose interest or forget to follow through.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale. A complete understanding of the present embodiments and the advantages and features thereof will be more readily understood by reference to the following detailed description when considered in conjunction with the accompanying drawings wherein:

FIG. 1 illustrates one embodiment of a computing system configured to provide an automated means for obtaining and processing interactive content associated with visual content;

FIG. 2A illustrates one embodiment of a user interface displaying visual content and an automated navigation system for obtaining and processing interactive content embedded within the visual content;

FIG. 2B illustrates one embodiment of a screenshot taken of a content frame of the visual content of FIG. 2A that is processed by an embedded content application.

FIG. 2C illustrates one embodiment of multiple embedded scannable content retrieved from the visual content of FIG. 2A that is processed by an embedded content application.

FIG. 3 illustrates one embodiment of a method performed by the system of FIG. 1 for creating visual content with embedded scannable content and distributing the visual content to a client computing device having an embedded content application for processing;

FIG. 4 illustrates one embodiment of a run-time or operational method associated with user interaction with the automated navigation system of FIG. 1; and

FIG. 5 illustrates an embodiment of a computing system configured with the example systems and/or methods disclosed.

### DETAILED DESCRIPTION

Systems and methods are described herein as associated with a computer-implemented automated means for obtaining and processing interactive content associated with visual content, in one embodiment. The automation serves to maintain user engagement and improve conversion rates by directly connecting viewers to specifically chosen webpage(s) or resource(s) obtained directly from within the displayed visual content. In one embodiment, the visual content may be configured to be embedded with instructions and/or data (e.g., code, text, link, visual data, etc. ,) that may be captured and processed by a computing device to retrieve or open a resource. In one embodiment, the automation may be facilitated by a viewer taking a screenshot of the displayed visual content on a computing device that triggers the computing device to perform an action of, for example, executing an algorithm, program, software, or application that processes the contents of the screenshot to open a webpage or obtain a resource. The resource may include displaying text, images, or video, opening a link or URL, or executing an application, program, browser, code, function, or algorithm. This process allows a content creator to include engaging or interactive content within, for example, their video that can be quickly and efficiently navigated to by viewers directly from within the displayed video.

In one embodiment, the present disclosure streamlines user engagement with social media content by embedding a scannable code (either a QR code or a proprietary code) within one or more content frames of a visual content. The user may view social media content through a computing device that includes an application configured for reading the embedded scannable code and guiding the viewer to the embedded resource. The user may grant or revoke permissions to the application and/or computing device to process (e.g., read, examine, scan, etc.,) one or more content frames of a visual content as desired. As an example, viewers take a screenshot of the content frame having an embedded scannable code using their computing device, the computing device executes, for example, an application that processes the embedded scannable code in the content frame and opens the resource, link, or app corresponding to the embedded scannable code of the content frame. In one embodiment, the application and/or computing device may be configured to subsequently delete the screenshot. Upon guiding the viewer to the embedded resource the screenshot may be deleted to ensure that the viewer's photo library is not cluttered with these temporary images. In one embodiment, the application may save the screenshot and store, tag and sort within an album or folder. Upon processing the embedded resource, the application may direct viewers to a specific online destination, like a product page, a website, a post, another social media profile, an e-commerce platform, another video, or any digital space the content creator wishes to direct their audience.

Moreover, each video may be embedded with a unique code that directs viewers to a specific location or resource instead of being directed to a generic landing page or a link tree that contains multiple links. Thus, there's no additional effort from the viewer to sift through various links to find the relevant one associated with a specific video. In contrast, the intended creator content is directly retrieved from each video thereby directly connecting a viewer with user engaging content as desired by the content creator. This process facilitates a streamlined user experience and improves user conversion rates by effectively and efficiently directing viewers to relevant content for user viewing or purchase. In certain embodiments, each content frame of the visual content may be specifically tailored using an embedded scannable code to display or retrieve a resource as desired by the content creator. Thus, the embedded scannable code may automate obtaining and processing of interactive content associated with visual content to streamline the interactive process for engaging viewers and driving traffic from social media platforms and streaming services to specific online destinations.

Further, by allowing each embedded scannable code to be customized to link to different destinations, user conversion and user engagement can be improved by giving content creators greater flexibility in their digital marketing strategies. For example, content creators can create a more targeted and effective campaign by configuring each video to serve a distinct purpose and lead the audience to a specifically chosen web page or resource. Moreover, the embedded scannable code may be implemented in user interaction analytics to give content creators insight into user engagement, success rates of code scans, and redirections.

The embedded scannable code may provide a direct, video-specific pathway to online destinations thereby providing a more personalized, efficient, and engaging user experience. Thus, the automated means for obtaining and processing interactive content associated with visual content of the present disclosure streamlines the user journey, reducing the number of steps and potential points of drop-off allowing viewers to easily access linked content without distraction of unrelated links or the need to navigate through a content creator's profile page.

In one embodiment, the embedded scannable content may be viewable in multiple sequential content frames of a video accompanied with a prompt and/or instructions to guide viewers to access the interactive content. For example, the prompt “Screenshot this!” may be displayed on multiple sequential frames to instruct viewers, in real-time, to take a screenshot of the video to access interactive content to engage with the content or creator the moment the content is provided in the video. Moreover, in certain embodiments, the application or computing device may automatically detect and read the embedded scannable content upon the viewer viewing the video or providing access to the application to access screenshots and photos. Furthermore, the embedded scannable content may appear at specific timestamps within the video encouraging continuous viewing of the video.

Previous manual navigation means for obtaining and processing interactive content associated with visual content often involve a lengthy or cumbersome process that can often hinder user experience and reduce user engagement. Other previous manual navigation means often required viewers to make significant efforts such as remembering and typing out URLs or navigating away from the viewable content to access links. Moreover, graphical user interfaces and social media and streaming services platforms often restrict linking in video descriptions to prevent spam and keep users on their platform thereby limiting direct redirection capabilities and making user navigation away from the content cumbersome.

With the present automated system for obtaining and processing interactive content associated with visual content, viewers are provided a direct and specific redirection from the visual content (e.g., social media video) to a unique online destination thereby eliminating the need for viewers to navigate through multiple links or remember URLs. By streamlining the user journey and simplifying the redirection process from visual content to the desired online destination, the present automated system for obtaining and processing interactive content associated with visual content can increase user engagement and conversion rates by minimizing user effort and potential friction points that could deter a viewer from following through to the online destination. Moreover, the automated navigation system of the present disclosure provides content creators with greater flexibility to customize each video with embedded scannable code that directs viewers to different yet specific and relevant destinations. Furthermore, the automated navigation system of the present disclosure provides content creators the ability to track and monitor viewer engagement for each embedded scannable code accessed and each online destination retrieved. These and other features are described herein with reference to the attached figures.

### System Embodiment

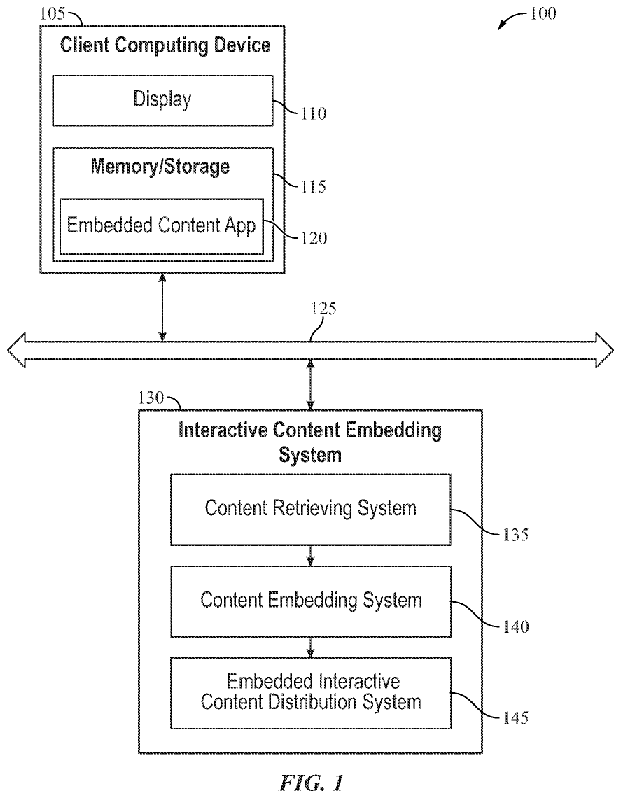

With reference to FIG. 1, one embodiment of a computing environment is illustrated that is configured with an automated navigation system 100 for obtaining and processing interactive content associated with visual content. In one embodiment, the automated navigation system 100 is configured to include a client computing device 105 and an interactive content embedding system 130 that includes a content retrieving system 135, a content embedding system 140, and an embedded interactive content distribution system 145. In one embodiment, the interactive content embedding system is configured to create a modified visual content by obtaining one or more visual content files and a corresponding one or more embeddable resource features (e.g., instructions, text, code, and/or data) for generating embedded scannable content (e.g., codes or graphics), and then embedding each embedded scannable content within a selected one or more content frames of the visual content to create the modified visual content. In one embodiment, the content retrieving system is configured to acquire embeddable resource features (e.g., instructions, links, URLs, text, code, and/or data) for generating a corresponding embedded scannable content. The modified visual content is then distributed by the interactive content embedding system to one or more client computing devices.

In one embodiment, the interactive content embedding system 130 may include, but is not limited to, a computer application/program that includes one or more algorithms configured to generate one or more modified visual content files based on one or more embeddable resource features. The algorithm comprises a set of algorithms and/or functions that generate embedded scannable content to overlay a visual content based on information and instructions provided by the content retrieving system. As an example, the embedded scannable content may include a prompt or instruction that simultaneously overlays the visual content with the embedded scannable content to give viewers notice that interactive content can be retrieved or accessed. Similarly, the client computing device 105 may include, but is not limited to, a computer application/program that includes one or more algorithms configured to decode and process the one or more modified visual content files (or content frames) based on the embedded scannable content. The algorithm comprises a set of algorithms and/or functions that process the embedded scannable content overlaid on the visual content to retrieve interactive content based on information and instructions provided in the embedded scannable content.

In one embodiment, the embeddable resource features may be encrypted by the interactive content embedding system 130 such that the generated embedded scannable content requires a proprietary application on the client computing device for processing the contents of the embedded scannable content and retrieving the embedded resource (e.g., online destination, product page, a website, post, e-commerce platform, etc.,).

As shown in FIG. 1, the computing environment (e.g., a cloud-computing environment) of the automated navigation system 100 may provide access to remote client devices such as client computing device 105 through one or more network communication channels 125 (e.g., a communication bus, wireless communication, wired networks, combinations of channels, etc.). A client device may access modified visual content via a graphical user interface through display 110 and an embedded content application 120 stored on or running from memory/storage device 115 to retrieve and process the embedded scannable content. The embedded content application 120 is configured to retrieve from the embedded scannable content one or more interactive content. The embedded scannable content may be embedded and visible on a plurality of sequentially displayed content frames of a visual content. Each embedded scannable content may include one or more data blocks associated with a resource or interactive content to be opened to retrieved. For example, each embedded scannable content may contain a data block for a URL, a data block for text, a data block for a post, a data block for an ecommerce platform, and so on. The embedded content application 120 may process each data block and retrieve its associated resource, for example, displaying text, images, or video contained within one or more data blocks, or executing at least one of: an application, program, browser, code, function, or algorithm contained within one or more data blocks. In one embodiment, the client computing device 105 may display the modified visual content with a table of contents of embedded scannable content, for example, a table or listing of selectable content frames and/or embedded scannable content for the viewer to view directly.

Moreover, the embedded content application 120 may be instantiated to run automatically based on a user interaction with the client computing device 105. For example, the embedded content application 120 may automatically run to retrieve and process embedded scannable content upon detecting user motion or audible communication. The client computing device 105 may include one or more sensors and/or one or more input devices for detecting user motion that may include: eye movements, hand movements, body movements, gestures, touch interaction on the computing device, keypress, screen swipe or press, or mouse click. Further, the user may provide one or more audible instructions to execute the embedded content application 120 to retrieve and process embedded scannable content.

In one embodiment, the user interaction executes the embedded content application 120 to automatically run and take a screenshot of a displayed content frame containing an embedded scannable content. Upon taking a screenshot of the content frame, the embedded content application 120 may then automatically process one or more content frames and the corresponding embedded scannable content to retrieve the encoded resource thereon. In one embodiment, the embedded content application 120 further includes capturing and temporarily storing the screenshot on the client computing device 105. Further, the embedded content application 120 may subsequently delete the captured and temporarily stored screenshot after having processed the embedded scannable content and/or retrieved the encoded resource thereon. In one embodiment, the embedded content application 120 may save the screenshot and store, tag and sort within an album or folder.

As described above, the interactive content embedding system 130 is configured to include a content retrieving system 135, a content embedding system 140, and an embedded interactive content distribution system 145. The content retrieving system 135, the content embedding system 140, and the embedded interactive content distribution system 145, may each include, but not be limited to, a computer application/program that includes one or more algorithms configured to retrieve visual content files, embed visual content files based and one or more embeddable resource features, and distribute modified visual content files to one or more client computing devices 105, respectively.

In one embodiment, the content retrieving system 135 may retrieve raw data (e.g., a video file) and additional information (e.g., instructions, links, URLs, text, code, and/or data) associated with the raw data for generating a visual content file having embedded scannable content for display on a social media platform or streaming services. The visual content having one or more content frames that will be embedded with the additional information. In one embodiment, the content embedding system 140 may embed the raw data (e.g., a video file) with the additional information (e.g., instructions, links, URLs, text, code, and/or data) associated with the raw data to generate a visual content file having embedded scannable content. The content embedding system 140 may include an algorithm that comprises a set of algorithms and/or functions that generate the embedded scannable content for overlaying on the visual content based on features of the visual content (e.g., color, background, and objects in the foreground and background) and information and instructions provided by the content retrieving system 135. In one embodiment, the embedded interactive content distribution system 145 may distribute the visual content file to one or more client computing device 105.

In one embodiment, the client computing device 105 may include wearable computing devices such as smart glasses or augmented reality (AR) headsets for receiving visual content with embedded scannable content. The wearable computing device may be configured to overlay the embedded scannable content on top of the visual content and process the content frame based on the user's ocular, facial, or body movements.

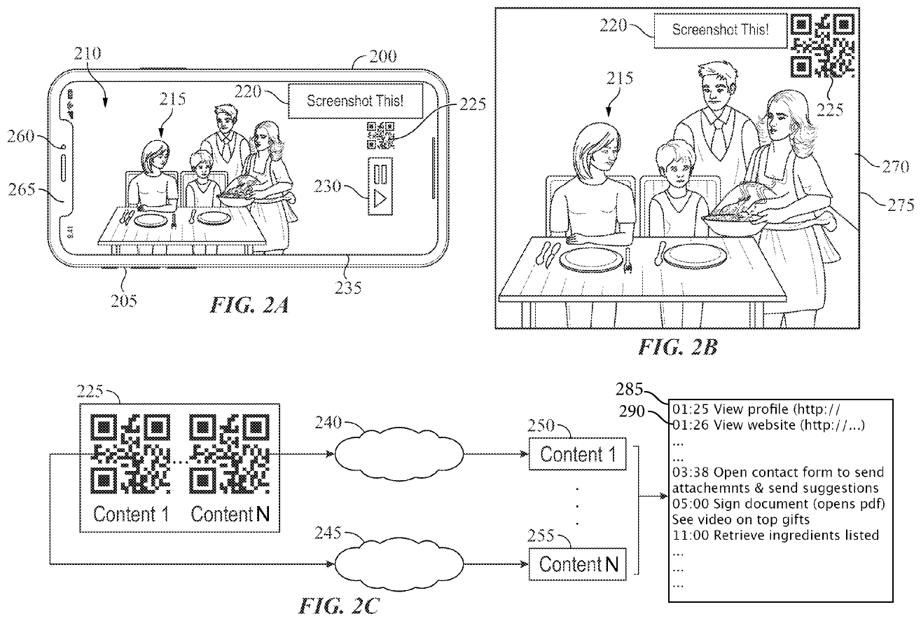

FIG. 2A illustrates one embodiment of a user interface displaying visual content and an automated navigation system for obtaining and processing interactive content embedded within the visual content. The graphical user interface 210 displays on a computing device 200 a content frame 215 of a visual content (e.g., a video) having an embedded scannable content 225. The embedded scannable content 225 may include additional information and/or a prompt 220 to inform the viewer that interactive content associated with the content frame or visual content can be retrieved. The graphical user interface 210 includes a navigation menu 230 that may pause, play, or take a screenshot of the visual content. Further, the computing device 200 may include pressable buttons 205 for manually taking a screenshot of the visual content. Moreover, the graphical user interface 210 may include a touch screen 235 for receiving user interactions such as, for example, touch interactions, key presses, pinch, fingerprint recognition, or swipe hand motions, and the like. The computing device 200 may include a camera 260 and one or more other sensors 265 for receiving user interactions and detecting features such as, for example, facial features, facial recognition, eye movements, hand movements, body movements, gestures, and the like. In one embodiment, the user interaction with the computing device 200 or the graphical user interface 210 may trigger the embedded content application to run and process the content frame 215.

FIG. 2B illustrates one embodiment of a screenshot taken of a content frame that is processed by an embedded content application. In one embodiment, the screenshot 270 includes the content frame 215, the embedded scannable content 225, and additional information and/or a prompt 220 to inform the viewer that interactive content associated with the content frame or visual content can be retrieved. The embedded content application 275 may temporarily save the screenshot to process the content frame 215. In one embodiment, the embedded content application 275 may request access to the user's media, for example, videos, images, and photographs. Upon the user granting access, the embedded content application 275 may process the user's images, videos, and photographs and prompt the user to retrieve embedded content resource information for each detected image or photograph having embedded scannable content. In certain embodiments, the embedded content application may be utilized to view streaming or saved media, upon detecting one or more embedded scannable content from the media, the embedded content application may be configured to automatically take a screenshot when an embedded scannable content appears on one or more content frames of the media. The viewer may then select to view now, or at a later time, the one or more embedded content as it appears throughout the media. In one embodiment, the embedded content application may display one or more embedded content in real-time as it appears in the media and allow the viewer to select and view or select and save (e.g., saving a screenshot of the content frames and embedded content) the one or more interactive content displayed throughout the media. In some embodiments, the embedded content application may immediately process the embedded content of a content frame and automatically direct the viewer to one or more resources or interactive content.

Referring to FIG. 2B, the embedded content application 275 may automatically detect and decode the embedded scannable content 225 and then redirect the user to the intended online destination encoded in the embedded scannable content 225. As an example, referring to FIG. 2C, the embedded scannable content 225 may include a plurality of content codes or content graphics that redirects viewers to different resources. For example, a QR code of Content 1 may direct the viewer through a network 240 for retrieving content 250 that may include a website, an e-commerce platform, another video, a post, or the like. A QR code of Content N may direct the viewer through a network 245 for retrieving content 255 that may include displaying text, images, or video, opening a link or URL, or executing an application, program, browser, code, function, or algorithm. In one embodiment, the embedded content application 275 may take a series of screenshots recursively to retrieve a plurality of codes from each content frame. Allowing the embedded content application 275 to scan and process a sequence of content or promotions provided by the content creator. The one or more resources, for example, Content 1 through Content N may be displayed as a resource listing 285 overlay on the visual content displayed or outside the visual content displayed. The resource listing 285 may include a timestamp 290 to allow users to guide directly to that content frame of the media or open the resource directly. In one embodiment, one or more resources associated with a media content, for example, Content 1 may be displayed individually as well encouraging users to view the entirety of the media content to see all available resources for user engagement. Further, the resource listing 285 at one or more timestamps 290 may be locked encouraging viewers to view a section or advertisement to access the interactive content. In certain embodiments, the actionable resources of the resource listing 285 may be displayed as an overlay on the visual content (similar to a prompt) while a corresponding content frame with interactive content is displayed when the visual content is viewed within the embedded content application or when the embedded content application is running in the background. Viewers may then select the actionable resource to process within the embedded content application.

In one embodiment, the embedded scannable content 225 may contain one or more encrypted codes that is only viewable by the embedded content application 275 for sensitive or exclusive content thereby enhancing security and privacy. Moreover, the embedded content application 275 may implement filters to detect and prevent redirects to malicious content or websites. Additionally, the embedded content application 275 may include or link to tracking, monitoring, and analytics tools to facilitate tracking of user engagement, success rate of code scans and redirections.

In one embodiment, the embedded content application 275 may include a content creator mode allowing users to embed scannable codes directly within their own video files or other media files. In certain embodiments, the embedded content application 275 may include the interactive content embedding system 130 allowing content creators to create and stream visual content having embedded scannable content directly from their broadband connection or internet service provider (ISP). Further, the embedded content application 275 may automatically detect and read screenshots from known or trusted sources. In certain embodiments, the embedded content application 275 may be configured to run in the background of a computing device to automatically detect and process embedded scannable content while the viewer is watching visual content having embedded scannable content. In many embodiments, the embedded content application 275 or the interactive content embedding system 130 may create a unique proprietary 2D or 3D scannable QR as an embedded scannable content 225 readable by the embedded content application 275. The embedded content application 275 or the interactive content embedding system 130 may encode running custom scripts, code, actions, and operations, for example, opening applications, accessing URLs, accessing, and playing media, accessing specific content within an application, URLs, or media, processing and running code for generating visual content or running custom scripts or apps, and the like. In many embodiments, the embedded scannable content 225 may include specific instructions to automate scanning, resource retrieval, and resource listing 285.

For example, viewers may view visual content with embedded scannable content 225, the embedded scannable content 225 may include code for automatically executing the embedded content application 275 and automatically scanning the embedded scannable content 225 to access and process the interactive content or one or more resources. In certain embodiments, the embedded scannable content 225 may be coded to perform any one of: automating execution of the embedded content application 275, scanning embedded scannable content 225 with the embedded content application to list resources, and automatically processing the embedded scannable content 225 to retrieve one or more resources. The embedded content application 275 may scan the proprietary code and display a list of resources associated with one or more content frames to allow viewers to select to view or access one or more interactive content. In this manner, the QR code 225 may support more robust and complex processes and the embedded content application 275 may process various resources to facilitate a more engaging and streamlined user experience upon viewing online or streaming content.

### Method for Creating Visual Content Embedded With Code for Interactive Content

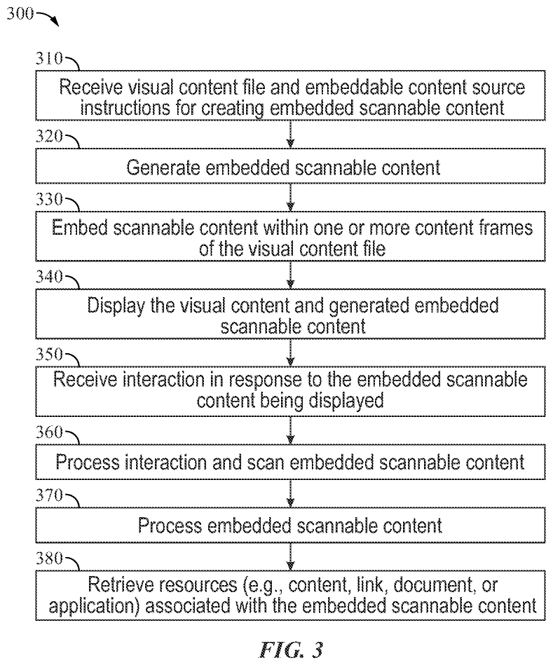

FIG. 3 illustrates one embodiment of a method 300 performed by the system of FIG. 1 for creating visual content with embedded scannable content and distributing the visual content to a client computing device 105 having an embedded content application 120 for processing. The method may include various programs, algorithms, logic, applications, and systems for retrieving visual content, generating the visual content with one or more embedded scannable content, displaying/distributing the visual content with embedded scannable content, receiving an interaction in response to displaying the visual content, and processing and retrieving the requested resources from the embedded scannable content. Each block shown in FIG. 3 may represent one or more processes, methods, or subroutines, carried out in the exemplary method. For explanatory purposes, method 300 will be described with reference to FIGS. 1 and 2A-2C which show example embodiments of carrying out the method of FIG. 3 for retrieving visual content, generating the visual content with embedded scannable content, and displaying/distributing, processing, and retrieving one or more requested resources from the embedded scannable content. Method 300 may be used independently or in combination with other methods or processes for retrieving visual content, generating the visual content with embedded scannable content, and displaying/distributing, processing, and retrieving one or more requested resources from the embedded scannable content. Method 300 may be performed by the embedded content application 120 of the client computing device 105, the interactive content embedding system 130, or both.

Method 300 begins at block 310, receiving one or more visual content files and one or more embeddable content source instructions for creating one or more embedded scannable content. In block 320, embedded scannable content is generated and then embedded within one or more content frames of the visual content file in block 330. In one embodiment, the generated embedded scannable content may include one or more prompts and/or instructions for viewers to open the embedded content application 120 to take a screenshot. In some embodiments, the one or more prompts and/or instructions may be added at a later time to the one or more content frames of the visual content file. In certain embodiments, the viewer can take one or more screenshots then execute the embedded content application 120 to select from the one or more screenshots to process. In block 340, the visual content and generated embedded scannable content is displayed for a viewer. In block 350, one or more interactions may be received in response to the embedded scannable content being displayed. In block 360, the interaction is processed, and the embedded scannable content is scanned by, for example, the embedded content application 120 to determine one or more resources contained therein to access or open. In block 370, the embedded scannable content is processed by the embedded content application 120, and the viewer is requested to select from one or more resources contained within the embedded scannable content to access or execute. In block 380, the viewer selected resources from the embedded scannable content is retrieved. The embedded content application 120 and/or computing device may retrieve the viewer selected resources from the embedded scannable content.

### Run-time or Operational Method

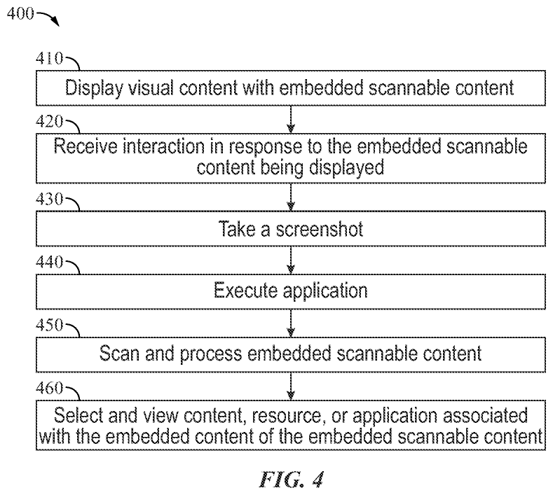

FIG. 4 illustrates one embodiment of a run-time or operational method 400 that is associated with a run-time or operational user interaction with the automated navigation system 100 of FIG. 1. The method may include various programs, algorithms, logic, applications, and systems for retrieving, displaying, and processing visual content having a one or more content frames with embedded scannable content. Each block shown in FIG. 4 may represent one or more processes, methods, or subroutines, carried out in the exemplary method. For explanatory purposes, method 400 will be described with reference to FIGS. 1 and 2A-2C which show example embodiments of carrying out the method of FIG. 4 for retrieving and processing visual content having a one or more content frames with embedded scannable content to streamline user engagement. Method 400 may be used independently or in combination with other methods or processes for retrieving and processing visual content having a one or more content frames with embedded scannable content to streamline user engagement. Method 400 may be performed by the embedded content application 120 of the client computing device 105, the interactive content embedding system 130, or both.

Method 400 begins at block 410, displaying visual content with embedded scannable content. The visual content may include one or more content frames, and one or more embedded scannable content. Each embedded scannable content may direct viewers to a unique or specific resource such as a URL. Moreover, the visual content may include multiple embedded scannable content that may be selectively accessed, and contents thereof retrieved by the viewer through an embedded content application. With reference to FIGS. 2A-2C, the embedded scannable content 225 may include multiple codes and prompts and instructions 220 for each embedded scannable code 225. The visual content containing embedded scannable content may be acquired by the client computing device from, for example, a streaming service, a social media platform, a storage system, a computing system, a network environment, or any combination thereof.

In block 420, an interaction may be received by a viewer in response to the embedded scannable content being displayed in one or more content frames of the visual content. In some embodiments, the interaction may be by viewer gesture, motion, or audible instruction or command. In one embodiment, the interaction may include taking a screenshot of the visual content displaying one or more content frames having the embedded scannable content. The interaction may trigger the embedded content application to run whereby the embedded content application may take a screenshot of the visual content and process the embedded scannable content. In certain embodiments, the viewer may see the prompt or instruction then take one or more screenshots by for example, using a head motion or hand gesture, then execute the embedded content application to select from the one or more screenshots to process through an audible command, or the like. In certain embodiments, the viewer can take one or more screenshots then execute the embedded content application 120 to select from the one or more screenshots to process.

In block 430, the client computing device may execute the embedded content application to take a screenshot or process a screenshot of one or more content frames having embedded scannable content. In some embodiments, the embedded content application may be configured to display the visual content from the screenshot and automatically process one or more content frames having embedded scannable content. In some embodiments, the embedded content application may be configured to access the user's media library to scan one or more screenshots or embedded codes. Subsequently, in block 440, the embedded content application scans and processes the embedded scannable content in block 450.

In block 460, the viewer may select from one or more resources within the embedded content, for example, opening a video, following a link or URL, displaying images or other content, accessing a resource, or executing one or more algorithms, programs, or applications. Subsequently, the viewer may delete the screenshot or configure the embedded content application to delete the screenshot. In one embodiment, the embedded content application 120 may save the screenshot and store, tag and sort within an album or folder.

### Definitions

A “visual content”, “video”, “media file”, or “visual content file” as used herein includes, but is not limited to, any singular or sequence of images or content frames that provide visual information to a viewer.

A “visual content with embedded content”, or “modified visual content” as used herein includes, but is not limited to, any visual content that has been modified from its original state to include embedded content.

### Computing Device Embodiment

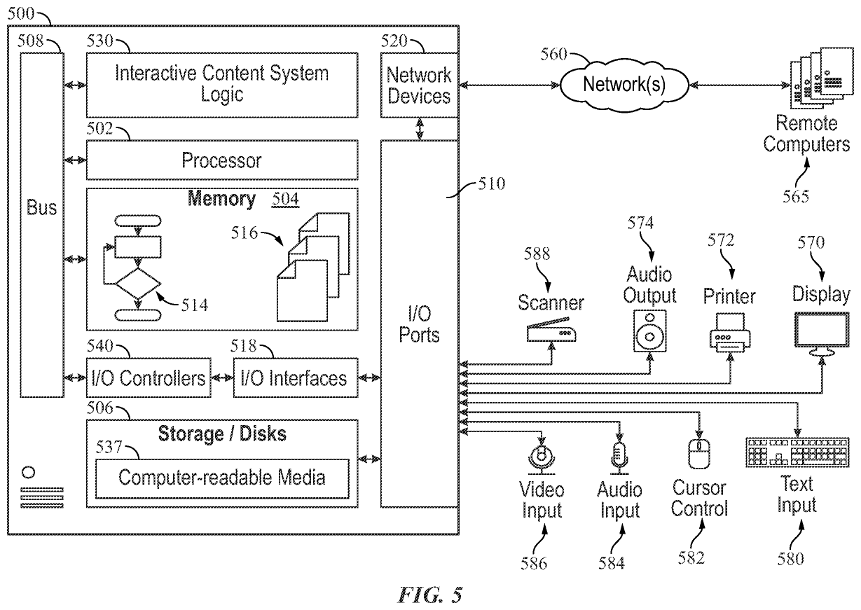

FIG. 5 illustrates an example computing device that is configured and/or programmed as a special purpose computing device with one or more of the example systems and methods described herein, and/or equivalents. The example computing device may be a computer 500 that includes at least one hardware processor 502, a memory 504, and input/output ports 510 operably connected by a bus 508. In one example, the computer 500 may include interactive content system logic 530 configured to facilitate retrieving visual content, generating the visual content with one or more embedded scannable content, displaying/distributing the visual content with embedded scannable content, receiving an interaction from a viewer in response to displaying the visual content, and processing and retrieving the viewer requested resources from the embedded scannable content as the automated navigation system 100 and associated figures. The interactive content system 530 generates and distributes visual content with embedded scannable content. In different examples, the logic 530 may be implemented in hardware, a non-transitory computer-readable medium 537 with stored instructions, firmware, and/or combinations thereof. While the logic 530 is illustrated as a hardware component attached to the bus 508, it is to be appreciated that in other embodiments, the logic 530 could be implemented in the processor 502, stored in memory 504, or stored in disk 506.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate serial or parallel execution of retrieving visual content, generating the visual content with one or more embedded scannable content, displaying/distributing the visual content with embedded scannable content, and receiving an interaction from a viewer in response to displaying the visual content through a graphical user interface to process and retrieve the viewer requested resources from the embedded scannable content. The means may also be implemented as stored computer executable instructions that are presented to computer 500 as data 516 that are temporarily stored in memory 504 and then executed by processor 502.

Logic 530 may also provide means (e.g., hardware, non-transitory computer-readable medium that stores executable instructions, firmware) for performing one or more of the disclosed functions and/or combinations of the functions.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output (I/O) interface (e.g., card, device) 518 and an input/output port 510 that are controlled by at least an input/output (I/O) controller 540. The disk 506 may be, for example, a magnetic disk drive, a solid-state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with, control, and/or be controlled by input/output (I/O) devices via the input/output (I/O) controller 540, the I/O interfaces 518, and the input/output ports 510. Input/output devices may include, for example, one or more displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 506, network devices 520, and so on. The input/output ports 510 may include, for example, serial ports, parallel ports, and USB ports.

The computer 500 can operate in a network environment and thus may be connected to the network devices 520 via the I/O interfaces 518, and/or the I/O ports 510. Through the network devices 520, the computer 500 may interact with a network 560. Through the network, the computer 500 may be logically connected to remote computers 565. Networks with which the computer 500 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
displaying, on a graphical user interface (GUI), an embedded scannable content and a media content, the embedded scannable content being configured for visual display during playback of the media content;
wherein the embedded scannable content includes information for retrieving an interactive content, the interactive content being configured to contain one or more data blocks;
receiving an interaction in response to the embedded scannable content being displayed;
processing the interaction, the interaction triggering retrieval and processing of the embedded scannable content;
retrieving, from the embedded scannable content, the interactive content; and
processing the one or more data blocks associated with the interactive content.

2. The method of claim 1, wherein displaying the media content comprises of displaying one or more content frames of the media content, and wherein the retrieved embedded scannable content is embedded in and retrieved from at least one or more content frames of the media content.

3. The method of claim 2, wherein retrieving, from the embedded scannable content, further comprises of capturing and temporarily storing the one or more content frames having the embedded scannable content.

4. The method of claim 2, further comprising storing the displayed embedded scannable content on a computing device, and retrieving and processing the one or more data blocks of the interactive content using an embedded content application for decoding the embedded scannable content.

5. The method of claim 1, wherein retrieving, from the embedded scannable content, further comprises of processing at least one of: the displayed media content, and the interactive content of the embedded scannable content to determine which of the one or more pieces data blocks to retrieve and process.

6. The method of claim 1, wherein processing the interaction comprises of detecting a motion by one or more sensors or one or more input devices of a computing device, and wherein the detected motion, triggering retrieval and processing of the embedded scannable content, includes at least one of: eye movements, hand movements, body movements, gestures, touch interaction, keypress, swipes, or mouse click.

7. The method of claim 1, wherein processing the interaction comprises of detecting an audible communication containing one or more instructions that triggers retrieval and processing of the embedded scannable content.

8. The method of claim 1, wherein processing the one or more data blocks associated with the interactive content further comprises of displaying text, images, or video contained within one or more data blocks, or executing at least one of: an application, program, browser, code, function, or algorithm contained within one or more data blocks.

9. A non-transitory computer-readable medium that includes stored thereon computer-executable instructions that when executed by at least a processor of a computer cause the computer to:
display, on a graphical user interface (GUI), an embedded scannable content and a media content, the embedded scannable content being configured for visual display during playback of the media content;
wherein the embedded scannable content includes information for retrieving an interactive content, the interactive content being configured to contain one or more data blocks;
receive an interaction in response to the embedded scannable content being displayed;
process the interaction, the interaction triggering retrieval and processing of the embedded scannable content;
retrieve, from the embedded scannable content, the interactive content; and
process the one or more data blocks associated with the interactive content.

10. The non-transitory computer-readable medium of claim 9, further comprising instructions that when executed by at least the processor cause the processor to:
display one or more content frames of the media content, and
retrieve embedded scannable content embedded in at least one of the one or more content frames of the media content.

11. The non-transitory computer-readable medium of claim 10, further comprising instructions that when executed by at least the processor cause the processor to:
capture and temporarily store the one or more content frames having the embedded scannable content.

12. The non-transitory computer-readable medium of claim 11, further comprising instructions that when executed by at least the processor cause the processor to:
storing the displayed embedded scannable content on a computing device, and
retrieving and processing the one or more data blocks of the interactive content using an embedded content application for decoding the embedded scannable content.

13. The non-transitory computer-readable medium of claim 9, further comprising instructions that when executed by at least the processor cause the processor to:
process at least one of: the displayed media content, and the interactive content of the embedded scannable content to determine which of the one or more pieces data blocks to retrieve and process.

14. The non-transitory computer-readable medium of claim 9, further comprising instructions that when executed by at least the processor cause the processor to:
process an interaction comprising detecting a motion by one or more sensors or one or more input devices of a computing device, and wherein the detected motion, triggering retrieval and processing of the embedded scannable content, includes at least one of: eye movements, hand movements, body movements, gestures, touch interaction, keypress, swipes, or mouse click.

15. The non-transitory computer-readable medium of claim 9, further comprising instructions that when executed by at least the processor cause the processor to:
process an interaction comprising detecting an audible communication containing one or more instructions that triggers retrieval and processing of the embedded scannable content.

16. The non-transitory computer-readable medium of claim 9, further comprising instructions that when executed by at least the processor cause the processor to:
process the one or more data blocks associated with the interactive content by displaying text, images, or video contained within one or more data blocks, or executing at least one of: an application, program, browser, code, function, or algorithm contained within one or more data blocks.

17. A computing system, comprising:
at least one processor connected to at least one memory;
a non-transitory computer readable medium including instructions stored thereon that when executed by at least the processor cause the processor to:
display, on a graphical user interface (GUI), an embedded scannable content and a media content, the embedded scannable content being configured for visual display during playback of the media content;
wherein the embedded scannable content includes information for retrieving an interactive content, the interactive content being configured to contain one or more data blocks;
receive an interaction in response to the embedded scannable content being displayed;
process the interaction, the interaction triggering retrieval and processing of the embedded scannable content;
retrieve, from the embedded scannable content, the interactive content; and
process the one or more data blocks associated with the interactive content.

18. The computing system of claim 17, wherein the instructions further include instructions that when executed by at least the processor cause the processor to:
display one or more content frames of the media content, and
retrieve embedded scannable content embedded in at least one of the one or more content frames of the media content.

19. The computing system of claim 18, wherein the instructions further include instructions that when executed by at least the processor cause the processor to:
capture and temporarily store the one or more content frames having the embedded scannable content.

20. The computing system of claim 19, wherein the instructions further include instructions that when executed by at least the processor cause the processor to:
storing the displayed embedded scannable content on a computing device, and
retrieving and processing the one or more data blocks of the interactive content using an embedded content application for decoding the embedded scannable content.
